(19) United States
(12) Patent Application Publication
(10) Pub. No.: US 2002/0067245 A1
(43) Pub. Date: Jun. 6, 2002

(54) Voice Activated remote keyless entry fob

(76) Inventors: Douglas C. Campbell, Northville, MI (US); Stephan Sydor, Farmington Hills, MI (US)

Correspondence Address: Ralph E. Smith, Brooks & Kushman P.C., 22nd Floor, 1000 Town Center, Southfield, MI, 48075-1551, US

(21) Appl. No.: 09/885,797

(22) Filed: Jun. 20, 2001

Related U.S. Application Data
(60) Provisional application No. 60/212,916, filed on Jun. 20, 2000.

(51) Int. Cl. H04Q 1/00; G05B 19/00

(52) U.S. Cl. 340/5.64; 340/5.72; 367/198

(57) ABSTRACT

A remote keyless entry (RKE) transmitter includes voice activated control capability to allow the transmitter to receive key word inputs to control operation of multiple systems and devices. The use of voice recognition and key word commands allows the RKE transmitter to be operated “hands-free.” In addition, the transmitter can be arranged to control a plurality of different devices on a vehicle, such as door locks, trunk, and horn, as well as other devices such as a garage door opener without requiring a larger housing to accommodate additional dedicated control buttons and circuitry.

This application claims the benefit of U.S. provisional application Ser. No. 60/212,916 filed Jun. 20, 2000.

### 1. FIELD OF THE INVENTION

The present invention generally relates to vehicle keyless entry systems, and more particularly, to an improved fob arrangement allowing “hands-free” operation.

### 2. BACKGROUND ART

Generally, remote keyless entry (RKE) systems are commonly integrated with vehicle locking systems to allow a user to lock and unlock vehicle doors, trunks, and control alarm systems without the need to use a key. Of particular concern to the present invention are RKE systems that use a portable transmitter unit as a code input device. The transmitter devices in such systems typically include a small, handheld transmitter housing in the form of a key fob that can be easily mounted to a user's key chain. One or more small switch buttons are located on the housing to allow the user to send the desired control signals to a receiver unit mounted on the vehicle.

While such RKE arrangements have significantly increased user convenience, these systems still require a user to physically grab the transmitter housing and actuate a switch button thereon. However, there are times when neither hand is readily free, thereby requiring the user to put down items they may have been carrying so that the transmitter can be grasped. As a consequence, a need exists for a RKE transmitter that can be operated “hands-free.”

Attempts have been made to provide a “hands-free” wireless-type lock control system that involve replacing the transmitter device with a passive transponder unit. One example is disclosed in U.S. Pat. No. 5,929,769 (Garnault). In this system a transmitter unit is located on the vehicle, and is arranged to communicate with a transponder carried by the user when ever the transponder is within a predetermined vicinity of the transmitter. If the transponder is authorized, the transmitter will control opening or unlocking of the vehicle member. The problem with such “passive” systems is that they are generally limited only to opening or unlocking functions, and require the user to be in very close proximity to the receiver.

Further, vehicle RKE systems are being expanded to provide control of other externally located devices, such as a home security or lighting system, and a garage door opener. Hand-held transmitter housings have limited real estate for additional switch buttons without undesirably making the housing larger. Hand-held “passive” systems would not have the capability of allowing control of these external devices from a remote location, such as while seated in the vehicle. As a consequence, a need exists for a RKE transmitter device capable of both “hands-free” operation, and for allowing control of multiple devices without a corresponding enlargement of the transmitter housing.

### SUMMARY OF THE INVENTION

It is therefore an object of the present invention to provide a remote keyless entry (RKE) transmitter that solves the above-noted problems by including a voice activated input capability to allow the transmitter to be operated hands-free.

It is a further object of the present invention to provide a remote keyless entry (RKE) transmitter having a voice activated input capability to allow the transmitter to receive inputs to control operation of multiple systems and devices without requiring additional size to accommodate additional, dedicated control switch buttons and circuitry.

In accordance with these and other objects, the present invention provides a remote keyless entry transmitter for selectively controlling operation of at least one device includes a microphone for receiving a voice command, and a processor programmed to detect and recognize the received voice command. The processor is arranged to generate a control signal associated with the voice command. The processor actuates a transmitter to transmit the control signal to a receiver unit to control operation of the device.

In accordance with one aspect of the invention, the processor includes a table of voice commands stored in a memory, with each voice command being associated with a specific operation control. The processor can be programmable so as to learn new voice commands. A programming switch can be provided on the transmitter housing to initiate a programming mode to allow the processor to learn and recognize voices of different users, or specific “key” words that can be used in operation of the transmitter.

In accordance with another aspect of the present invention, the transmitter can be arranged to control operation of several different devices, including door locks, trunk, and horn on a vehicle, as well as a garage door opener and home lighting and security systems. The use of voice commands eliminates the need for dedicated switch buttons on the transmitter housing.

In accordance with yet another aspect of the present invention, a method is provided for remotely controlling operation of a lock on a vehicle which includes receiving a voice command from a microphone mounted to a portable fob housing, detecting and recognizing the received voice command, and generating a control signal associated with a recognized voice command. The control signal is transmitted to a receiver unit located on the vehicle to control operation of the lock. The method can also include receiving a keyword voice command associated with controlling operation of at least one device in addition to the vehicle lock, generating a control signal associated with the received keyword, and transmitting the control signal to control operation of the associated device.

In accordance with still another aspect of the present invention, a improved RKE transmitter is provided where the improvement includes a microphone mounted to the fob housing for receiving a voice command, and a processor connected to the microphone and arranged to detect and recognize the received voice command. The processor is further arranged to provide to the transmitter a control signal associated with the recognized voice command.

The above objects and other objects, aspects, features, and advantages of the present invention are readily apparent from the following detailed description of the best mode for carrying out the invention when taken in connection with the accompanying drawings.

### BRIEF DESCRIPTION OF DRAWINGS

FIG. 1 is an elevated and exploded view of a RKE transmitter fob having a voice recognition capability in accordance with the present invention; and

FIG. 2 is a block circuit diagram of the RKE transmitter in accordance with an exemplary embodiment of the present invention.

### DETAILED DESCRIPTION OF THE PREFERRED EMBODIMENT(S)

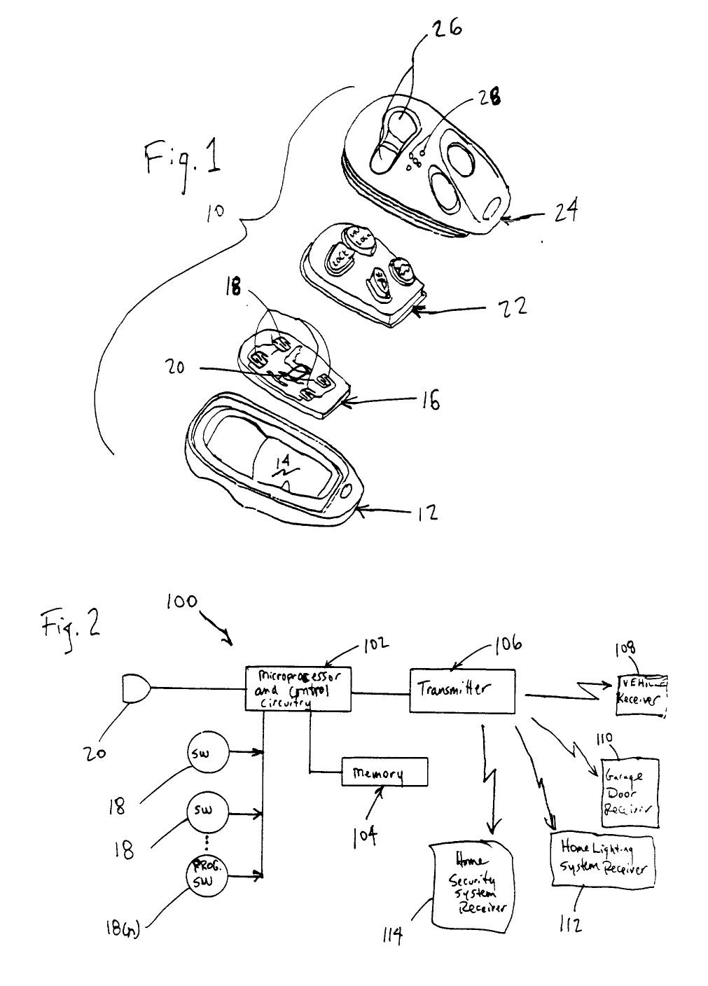

Referring to FIG. 1, an RKE transmitter fob 10 is shown in accordance with one embodiment of the present invention as formed from an assembly of different components. More specifically, transmitter 10 includes a handheld base housing portion 12 having an internal space 14 for receiving and holding a printed circuit board 16. The circuit board includes transmitter circuitry as described in connection with FIG. 2, as well as at least one switch (four are shown) 18 and a microphone 20. A switch mat 22 is positioned on top of the circuit board to act as a keypad for actuation of each switch 16, and an upper housing portion 24 mates with base portion 12 to complete assembly. Upper housing portion 24 is formed with openings 26 that align with the respective switch keys of switch mat 22 to allow the switch keys to be accessible to a user, and openings 28 that facilitate the passage of sound to the microphone after the housing is assembled. Except as discussed below, the manner and material used to form each transmitter component is known to those skilled in the art.

Referring now to FIG. 2, a block circuit diagram shows an exemplary embodiment 100 for the transmitter circuit in accordance with the present invention. Microphone 20 is connected to a processor and control circuit 102, which includes a suitable type of memory arrangement denoted as element 104. The processor is preferably implemented as a microprocessor based circuit, however other suitable dedicated processing circuit, such as an ASIC device, can also be used.

Processor and control circuit 102 are connected to a transmitter circuit 106, such as an radio frequency (RF) transmitter arranged to send signals using any known encryption method. In a preferred embodiment, a set of switches 18, which can include a program switch 18(n), are connected to processor and control circuit 102 to allow a user to control/select operation of the transmitter. The transmitter includes suitable coding and programming to allow communication of control signals to a plurality of different remote system or devices. As shown in the exemplary embodiment, these remote system can include a receiver 108 mounted to the vehicle which allows the user to lock and unlock vehicle doors or operate other devices on the vehicle, such as the trunk or horn, a receiver 110 in a garage door opening system, a receiver 112 in a home and lighting control system, and/or a receiver 114 in a home security system.

In accordance with the present invention, processor 102 is programmed in accordance with know voice or speech recognition techniques to detect and recognize various voice commands received via the microphone. The respective voice commands can be stored in memory 104 by the user such as by using of the program key 18(n). The processor is further programmed/arranged to generate a control signal associated with the voice command that actuates transmitter 106 to transmit the control signal to the appropriate receiver unit to control operation of the device.

For example, processor 102 can include a table of voice commands stored in memory 104, with each voice command being associated with a specific operation control. The processor is preferably programmable so as to learn new voice commands. Programming switch 18(n) can be arranged to initiate or launch a programming mode to allow the processor to learn and recognize voices of different users, or specific “key” words that can be used in operation of the transmitter.

In operation, a user will only need to call out the appropriate control command, and transmitter 10 will automatically send the desired control signal to the proper receiver. Thus, the present invention is able to provide a truly “hands-free” RKE transmitter. In addition, with the use of word commands that cause the processor 102 to access different control menus for the selected device or system to be controlled, the present invention provides a portable RKE transmitter that can eliminate the need for dedicated switch buttons on the transmitter housing. In other words, the same key switch or switches can be readily used for each different remote system or device by associating respective voice commands to change the assigned function of a physical key. This allows the present invention to further reduce the size and hardware requirements of a multi-use RKE transmitter.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A remote keyless entry (RKE) transmitter for selectively controlling operation of at least one device comprising:
a portable fob housing;
a microphone mounted to the fob housing for receiving a voice command;
a processor connected to the microphone and arranged to detect and recognize the received voice command, wherein the processor is arranged to generate a control signal associated with the recognized voice command; and
a transmitter responsive to the processor for transmitting the control signal to a receiver unit to control operation of the at least one device.

2. The transmitter of claim 1 wherein the processor comprises a microprocessor programmed to recognize a received voice command and generate an associated control signal.

3. The transmitter of claim 1 further comprising a memory connected to the processor for storing a table of key words, each of which is associated with a selected one of a plurality of control signals.

4. The transmitter of claim 3 wherein the processor is arranged to learn a new key word, and store the learned key word in the table in place of a key word already stored in the table.

5. The transmitter of claim 3 wherein the processor is arranged to learn a new key word, and store the learned key word in the table in association with a selected control signal.

6. The transmitter of claim 1 wherein the processor is arranged to learn a key word, and store the learned key word in a memory in association with a selected control signal.

7. The transmitter of claim 6 further comprising a programming switch located on the housing for initiating a learning mode for the processor.

8. The transmitter of claim 1 wherein the processor is arranged to learn different authorized voice signatures.

9. The transmitter of claim 1 wherein the processor is arranged to generate control signals for controlling operation of a plurality of devices, wherein a key word voice command is associated with each control signal.

10. The transmitter of claim 9 wherein the processor is arranged to generate control signals to control operation of a vehicle door lock and a garage door opener.

11. The transmitter of claim 9 wherein the processor is arranged to generate control signals to control operation of a vehicle door lock and a home lighting system.

12. The transmitter of claim 9 wherein the processor is arranged to generate control signals to control operation of a vehicle door lock and a home security system.

13. A method for selectively controlling operation of a lock on a vehicle comprising:
receiving a voice command from a microphone mounted to a portable fob housing;
detecting and recognizing the received voice command;
generating a control signal associated with a recognized voice command; and
transmitting the control signal to a receiver unit located on the vehicle to control operation of the lock.

14. The method of claim 13 further comprising:
receiving a keyword voice command associated with controlling operation of at least one device in addition to the vehicle lock;
generating a control signal associated with the received keyword; and
transmitting the control signal to control operation of the associated device.

15. The method of claim 14 wherein the additional device comprises a garage door opener.

16. The method of claim 14 wherein one of the plurality of additional devices comprises a home lighting system.

17. The method of claim 14 wherein the additional device comprises a home security system.

18. A remote keyless entry (RKE) transmitter for selectively controlling operation of a lock on a vehicle, the RKE transmitter comprising:
a portable fob housing; and
a transmitter arranged to transmit a control signal to a receiver unit located on the vehicle to control operation of the lock, wherein the improvement comprises:
a microphone mounted to the fob housing for receiving a voice command;
a processor connected to the microphone and arranged to detect and recognize the received voice command, wherein the processor is arranged to provide to the transmitter a control signal associated with the recognized voice command.

19. The transmitter of claim 18 wherein the improvement further comprises a memory connected to the processor for storing a table of key words, each of which is associated with a selected one of a plurality of control signals.

20. The transmitter of claim 19 wherein the processor is arranged to learn a new key word, and store the learned key word in the table in association with a selected control signal.
